(19) United States
(12) Patent Application Publication
(10) Pub. No.: US 2013/0333733 A1
(43) Pub. Date: Dec. 19, 2013

(54) Single Pass Roller Cleaner

(71) Applicant: Robert Craig Harrison, Magnolia, TX (US)

(72) Inventor: Robert Craig Harrison, Magnolia, TX (US)

(21) Appl. No.: 13/527,020

(22) Filed: Jun. 19, 2012

(51) Int. Cl. B08B 3/02

(52) U.S. Cl. 134/200

(57) ABSTRACT

This Paint Roller Cover Cleaner is a cylindrical fixture that has an annular opening near the opened end where the paint roller is inserted. When the valve lever is depressed water flows from the annulus and is injected into the nap of the roller cover. Water-paint mixture is then forced out the end of the fixture. As the roller cover is pushed further into the fixture it is cleaned 360 degrees simultaneously and from one end to the other. Water-paint mixture is never allowed to flow back onto a cleaned portion of the roller cover.

REFERENCES CITED

| Patent No | Filing Date | Inventor | Classes |
|---|---|---|---|
| U.S. Pat. No. 2,985,178 | Feb. 8, 1960 | Christensen | 134-149 |
| U.S. Pat. No. 3,421,527 | Apr. 12, 1966 | Dettman | 134-138 |
| U.S. Pat. No. 4,126,484 | Jun. 1, 1977 | Monteiro | 134/34; 134/38; 134/182 |
| U.S. Pat. No. 4,377,175 | Aug. 18, 1980 | Fritz | 134/138; 134/143; 134/149; 68/213 |
| U.S. Pat. No. 4,380,478 | Oct. 5, 1981 | Cooney | 134/38; 68/213; 134/117 |
| U.S. Pat. No. 4,517,699 | Apr. 19, 1984 | Petricka | 15/104.04; 15/104.92; 68/213; 134/199 |
| U.S. Pat. No. 4,606,777 | Apr. 21, 1983 | Brow | 134/38; 15/104.04; 15/104.92; 68/213; |
| | | | 134/34; 134/138; 134/199 |
| U.S. Pat. No. 5,452,734 | Jan. 23, 1995 | Steeves | 134/186; 15/236.03; 134/900 |
| U.S. Pat. No. 5,487,399 | Mar. 23, 1995 | Hannah | 134/138; 134/152; 134/170; 134/900 |
| U.S. Pat. No. 6,079,429 | Nov. 16, 1998 | Zarich | 134/182; 134/900 |

### FIELD OF THE INVENTION

This invention relates generally to cleaning devices for cylindrical rollers, and more particularly to an apparatus for cleaning paint from re-usable rollers.

### BACKGROUND OF THE INVENTION

During the process of painting, and in the context of various forms of coating application, it is common to use a rotatable cylindrical applicator called a roller to apply coatings to a surface. Some rollers are designed for re-use, and others as disposable items, but tradesmen have been able to re-use both kinds of roller by cleaning the roller between uses. The most simplistic method involves immersing the roller in a bucket of solvent while scrubbing, rubbing, or otherwise agitating the roller in the solvent. This method is inefficient, messy, and potentially hazardous. Therefore, several different types of roller cleaning devices have been designed to improve upon the solvent-and-bucket method. Such devices allow for the re-use of paint rollers by cleaning old paint from the roller in preparation for re-use. In comparison to traditional methods or disposal of used rollers, such cleaning devices reduce solid waste, reduce parts inventory and carriage, and provide an environmentally friendly alternative to discarding rollers after limited use. Various device configurations exist, some relying upon mechanical agitation, some upon solvent immersion or solvent flushes (see e.g. U.S. Pat. No. 6,079,429), and some upon a combination of solvent and agitation (see e.g. U.S. Pat. No. 5,452,734). Devices such as the '429 reference consume a large volume of a solvent such as water applied at low pressure and thus exhibit drawbacks such as the volume of solvent required, the volume of effluent, and limited cleaning efficacy. Devices such as the '734 reference seek to reduce solvent usage over predecessor designs, but in doing so, require multiple introductions of the roller into solvent which becomes increasingly contaminated by the substance intended to be cleansed. Other apparatus such as the Dettman device (U.S. Pat. No. 3,421,527) utilize sprays or streams of solvent directed to the roller, preventing direct reintroduction of contaminated solvent, but failing to ensure a consistent gap-less application of solvent across the entire surface of the roller. Such devices may attempt to mitigate coverage problems by requiring rotation of the roller, apparatus, or both, and may increase complexity and potential for malfunction if automatic rotation is incorporated into the device. Due to such limitations each of the prior art references suffers from detriments, which this invention overcomes.

### SUMMARY OF THE INVENTION

This invention is an apparatus for cleaning rollers with a 360-degree jet of solvent applied to the roller surface that removes unwanted coating and contaminants from the roller. The invention is easy to use, requires less maintenance than prior art designs, and provides improved cleaning efficiency over the prior art. The 360-degree jet keeps the interior of the apparatus free from coatings and contaminants while protecting the cleaned surface of the roller from recontamination by effluent solvent.

One embodiment provides a housing with an interior compartment having a receiving opening configured to receive a roller for processing with a fluid; an end cap sealingly coupled with the housing and having an annulus configured to receive a roller, the end cap having a fluid passage in fluid communication with an injection gap formed between the terminus of the exterior housing and the interior surface of the end cap, the injection gap to apply effluent to the roller via an ejection output of the fluid applied continuously along the circumference of the roller; and a regulator in fluid communication with the fluid passage, the regulator to regulate a flow of the fluid from a pressurized source into the fluid passage.

### BRIEF DESCRIPTION OF THE DRAWINGS

FIG. 1 is a cross-sectional side view showing the apparatus absent a roller.

FIG. 2 is a cross-sectional view of the apparatus, taken along line 2-2 of FIG. 1.

FIG. 3 is an exterior side view of the apparatus.

FIG. 4 is a cross-sectional side view showing the operation of the apparatus with an inserted, partially cleaned roller.

### DETAILED DESCRIPTION

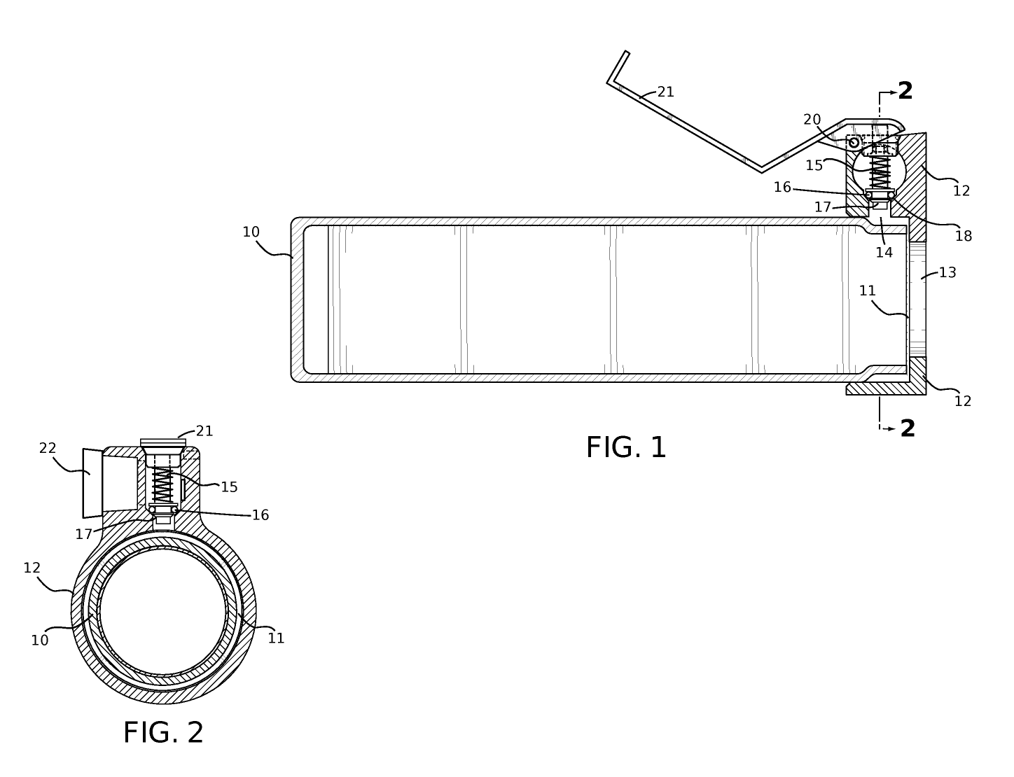

FIG. 1 illustrates the components of one embodiment of the invention. In this embodiment, the apparatus comprises a cylindrical exterior housing 10 terminated in an end cap 12 and separated from the end cap by an injection gap 11. The end cap 12 includes an annulus 13 for insertion of a roller. The end cap 12 includes a fluid passage 14 for introduction of fluid into the injection gap 11. The flow of fluid through the passage 14 is regulated by a valve 17 that, when closed, compresses an O-ring 16 against the valve seat 18 that is formed within the end cap 12. The state of the valve 17 is controlled by a known spring actuator 15, which applies pressure to the valve 17. The spring actuator 15 is connected to an actuator handle 21 such that when pressure is applied to the actuator handle 21, the handle rotates about a pivot pin 20 causing the valve 17 to open the fluid passage 14 and permit pressurized fluid to flow through the injection gap 11 and into the body of the apparatus. The invention may also be adapted to use a push-button, toggle, or other known instrument for activating the actuator 15. In the embodiment depicted in FIG. 1, the actuator handle 21 is formed in the shape of a grip to allow one-handed use of the apparatus. The actuator handle 21 is oriented such that it becomes parallel with the cylindrical exterior housing when depressed. This frees the operator to use his or her other hand to control the solvent source or manipulate the roller.

FIG. 2 illustrates a cross-sectional view of the apparatus, taken along line 2-2 of FIG. 1. In FIG. 2 the sectional relationship of the exterior housing 10 and the end cap 12 may be observed. In the depicted embodiment the radius of the exterior housing's 10 section is less than the radius of the end cap 12 into which the housing 10 is inserted. The difference in radii permits the injection gap 11 additional clearance for flow of solvent 360 degrees around the annulus 13. The width and height of the injection gap 11 may be varied in construction of the apparatus to accommodate various pressures of solvent flowing in through the fluid passage 14. FIG. 2 illustrates an embodiment including a female coupling 22 for connection to a solvent source. Any number of known couplings may be used to connect to pressurized solvent sources, such as a hose bib, hose end connection, or solvent tank. For example, when an operator is cleaning a water-based paint, the preferred coupling 22 may be a threaded female coupling for connection to a threaded male end of a traditional water hose.

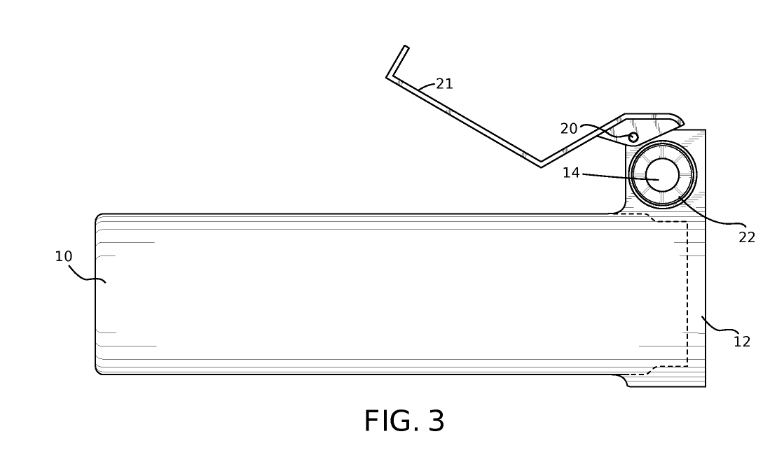

FIG. 3 is a side view of the apparatus illustrating the exterior appearance of the constructed apparatus. The exterior housing 10 and end cap 12 may be constructed of any sufficiently rigid material capable of withstanding the pressure of the solvent delivered through the coupling 22, fluid passage 14 (not pictured in FIG. 3, see FIG. 2) and injection gap 11 (not pictured in FIG. 3; see FIG. 2). Such materials may include, but are not limited to, corrosion-resistant metals such as aluminum, plastics such as PVC, ABS, and HDPE, or composites. The end cap 12 may be secured to the exterior housing 10 by any number of known construction methods appropriate to the material choice such as threaded connection, adhesive, solder, welding, or other suitable technique. As illustrated in FIG. 3, connections made by compression, thermal fusion, solder, welding, or epoxy allow the cylindrical exterior housing 10 to appear to the user as a continuous unit incorporating the end cap 12. As illustrated in FIG. 3, a coupling 22 may employ a tapered connection to the fluid passage 14 (see FIG. 2) such that the solvent pressure increases as it passes into the end cap 12.

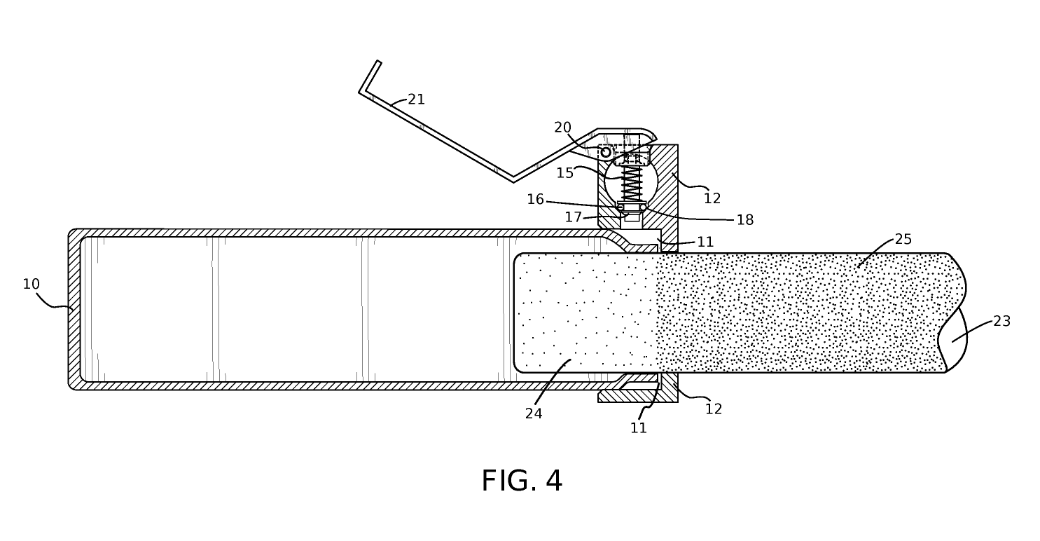

FIG. 4 is a cross-sectional side view with similarity to FIG. 1. FIG. 4 illustrates a roller 23 being cleaned by the apparatus. In FIG. 4, the roller 23 is shown partially inserted through the annulus 13 such that the exterior surface (the “nap”) of the roller 23 contacts the inner surface of the end cap 12 through the annulus 13 during insertion into the exterior housing 10. The low-density stippling on the illustration of the roller 23 in FIG. 4 represents the cleaned roller nap 24, while the high-density stippling illustrates the contaminated or un-cleaned roller nap 25.

The apparatus is connected to a solvent source via the coupling 23, and oriented so that processed fluid will escape the apparatus through the annulus in the end cap. To clean a roller 23, the operator depresses the actuator handle 21, enabling solvent to be communicated from its source through the coupling 22 into the fluid passage 14, and through the injection gap 11 into the body of the housing 10, for so long as the actuator valve 17 is held open by continued pressure on the actuator handle 21. As the roller 23 is inserted through the annulus 13, solvent exiting the fluid passage 14 is forced through the injection gap 11 at high pressure, forming a continuous 360 degree jet of solvent that penetrates the porous uncleaned roller nap 25 and flows through and across the uncleaned nap 25, exiting through the annulus 13, thus carrying the contaminated solvent away from the cleaned roller nap 24 which is protected from further contamination or back-spatter by the closed exterior housing 10.

Once the entire roller 23 has passed through the annulus 13 and has been cleaned by the continuous jet of solvent exiting the injection gap 11, the roller 23 may be removed from the apparatus. If the operator releases the actuator handle 21, the spring actuator 15 closes the valve 17 by compressing the O-ring 16 between the valve 17 and the valve seat 18. Solvent flow stops and the roller 23 may be removed. Removal occurs by withdrawing the roller 23 in the opposite direction through the annulus 13. This allows the operator to perform a cleaning operation using a minimum of solvent. In the case of a highly contaminated roller 23, an operator may wish to enable the apparatus to continue applying solvent to the cleaned roller nap 24 during removal of the roller 23. In such a situation, the operator may continue to hold down the actuator handle 21 during withdrawal of the roller 23 to maintain a continuous 360-degree solvent flow from the injection gap 11 during the removal. This permits a second cleaning pass to be applied to the cleaned roller nap 24 without requiring rotation, agitation, or re-insertion of the roller 23.

Although the foregoing details describe various embodiments of the invention, persons reasonably skilled in the art will recognize that various changes may be made in the details of the apparatus or method of this invention without departing from the spirit and scope of the invention as defined in the appended claims. The present invention includes several independently meritorious inventive aspects and advantages. Unless compelled by the claim language itself, the claims should not be construed to be limited to structures that incorporate all of the inventive aspects, or enjoy all of the advantages, disclosed herein.

It is well established that the claims of the patent serve an important public notice function to potential competitors, enabling them to not only determine what is covered, but also what is not covered by the patent. A number of precedential court decisions have emphasized the importance of discerning the patentee's intent, as expressed in the specification, in construing the claims of the patent. It is my intent that the claims receive a liberal construction and be interpreted to uphold and not destroy the scope of the claims or the rights of the inventor. It is my intent that the claim terms be construed in a charitable and common sense manner, in a manner that encompasses the embodiments disclosed in the specification and drawings without incorporating unrecited or unnecessary limitations. It is my intent that the claim terms be construed as broadly as practicable while preserving the validity of the claims. It is my intent that the claim terms be construed in a manner consistent with the context of the overall claim language and the specification, without importing extraneous limitations from the specification or other sources into the claims, and without confining the scope of the claims to the exact representations depicted in the specification or drawings. It is also my intent that not each and every term of the claim be systematically defined and rewritten. Claim terms and phrases should be construed only to the extent that it will provide helpful, clarifying guidance to the finder of fact, or to the extent needed to resolve a legitimate, good faith dispute that is material to the questions of validity or infringement. Otherwise, simple claim terms and phrases should be presented without any potentially confusing and difficult-to-apply definitional construction.

It is also to be understood that the terminology employed in the Summary of the Invention and Detailed Description sections of this application is for the purpose of illustration and description of the particular embodiments. It is not intended to be exhaustive or limit the invention to the precise form described and numerous variations or modifications are possible in light of the above teachings. In this specification and the appended claims, the singular forms “a,” “an” and “the” include plural references unless the context clearly dictates otherwise. Conversely, it is contemplated that the claims may be drafted to exclude any optional element or be further limited using exclusive terminology as “solely,” “only” and the like in connection with the recitation of claim elements or by use of a “negative” limitation. It is also contemplated that any optional feature of the inventive variations described herein may be set forth and claimed independently, or in combination with anyone or more of the features described herein.

It is my intent that the claims of this patent be construed and enforced liberally and in a manner affording the fullest protection of the arts and inventions disclosed herein.

Table of Figure References

| | |
|---|---|
| 10 | exterior housing |
| 11 | injection gap |
| 12 | end cap |
| 13 | annulus |
| 14 | fluid passage |
| 15 | spring actuator (known) |
| 16 | o-ring |
| 17 | valve |
| 18 | valve seat |
| 19 | UNUSED |
| 20 | pivot pin |
| 21 | actuator handle |
| 22 | coupling |
| 23 | roller |
| 24 | cleaned roller nap |
| 25 | uncleaned roller nap |

I claim:

1. A fluid application apparatus comprising:
a housing with an interior compartment having a receiving opening configured to receive a roller for processing with a fluid;
an end cap sealingly coupled with the housing and having an annulus configured to receive a roller, the end cap having a fluid passage in fluid communication with an injection gap formed between the terminus of the exterior housing and the interior surface of the end cap, the injection gap to apply effluent to the roller via an ejection output of the fluid applied continuously along the circumference of the roller; and
a regulator in fluid communication with the fluid passage, the regulator to regulate a flow of the fluid from a pressurized source into the fluid passage.

2. The apparatus of claim 1, further comprising:
a supplemental fluid passage in fluid communication with the injection gap; and
a supplemental regulator in fluid communication with the supplemental fluid passage, the supplemental regulator to regulate a flow of a supplemental fluid from a source into the supplemental fluid passage.

3. The apparatus of claim 1, wherein the regulator comprises a valve.

4. The apparatus of claim 3, wherein the regulator further comprises an actuator coupled with the valve, the actuator to adjust the valve position.

5. The apparatus of claim 1, wherein the housing comprises a cylindrical housing.

6. The apparatus of claim 5, wherein the injection gap comprises a circular loop disposed at the receiving opening.
